(19) United States
(12) Patent Application Publication
(10) Pub. No.: US 2025/0157306 A1
(43) Pub. Date: May 15, 2025

(54) METHODS AND SYSTEMS FOR CONTENT MANAGEMENT

(71) Applicant: Comcast Cable Communications, LLC, Philadelphia, PA (US)

(72) Inventors: Paul Palaganas, Philadelphia, PA (US); Bharat Mudegowder, Philadelphia, PA (US); John Kennedy, Philadelphia, PA (US)

(21) Appl. No.: 18/507,635

(22) Filed: Nov. 13, 2023

(51) Int. Cl. G07F 17/32; H04N 21/258

(52) U.S. Cl. CPC G07F 17/3288; H04N 21/25891

(57) ABSTRACT

Methods and systems for content consumption management and determining gaming and wagering opportunities based thereon are described. As a user consumes content, a content history may be determined. One or more supplemental features, such as a series of gaming or wagering opportunities, may be determined and sent to a user device based on the content consumption history.

### BACKGROUND

Currently there is little sharing of information between content and service providers, such as home automation service providers, and certain other third party service providers such as gaming and wagering service providers. Thus, third parties that may desire to provide interactive features to consumers do not possess the information required to determine which interactive features to provide, or when and how to provide them. For example, gaming or wagering service providers do not know which features or wagers to offer a user, absent the user explicitly selecting the wagers. These and other shortcomings are identified and addressed by the disclosure.

### SUMMARY

It is to be understood that both the following general description and the following detailed description are exemplary and explanatory only and are not restrictive. Methods and systems for content and feature management are provided. A user's content consumption and data usage behavior may be monitored and analyzed to determine supplemental features such as wagering opportunities to offer the user.

### BRIEF DESCRIPTION OF THE DRA WINGS

The accompanying drawings, which are incorporated in and constitute a part of this specification, show examples and together with the description, serve to explain the principles:

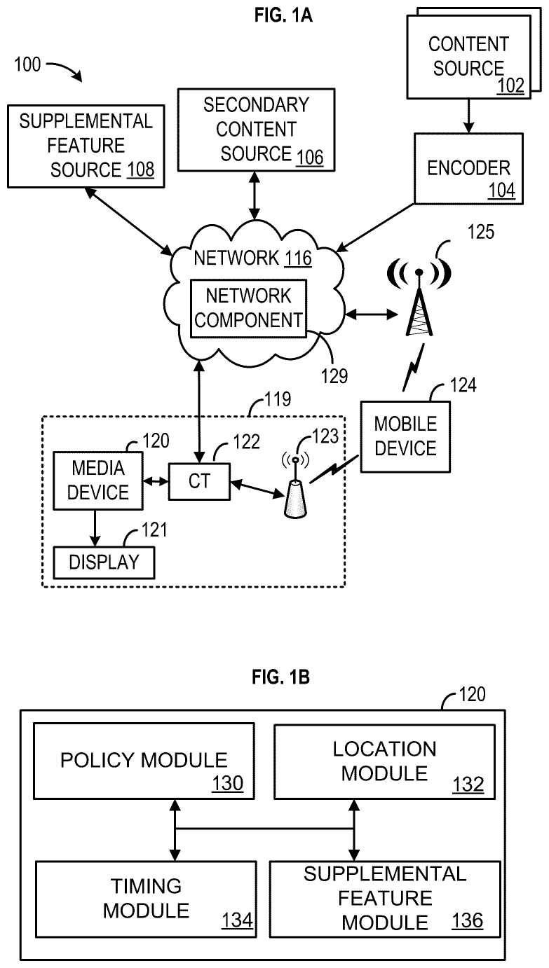

FIGS. 1A-1B show an example system;

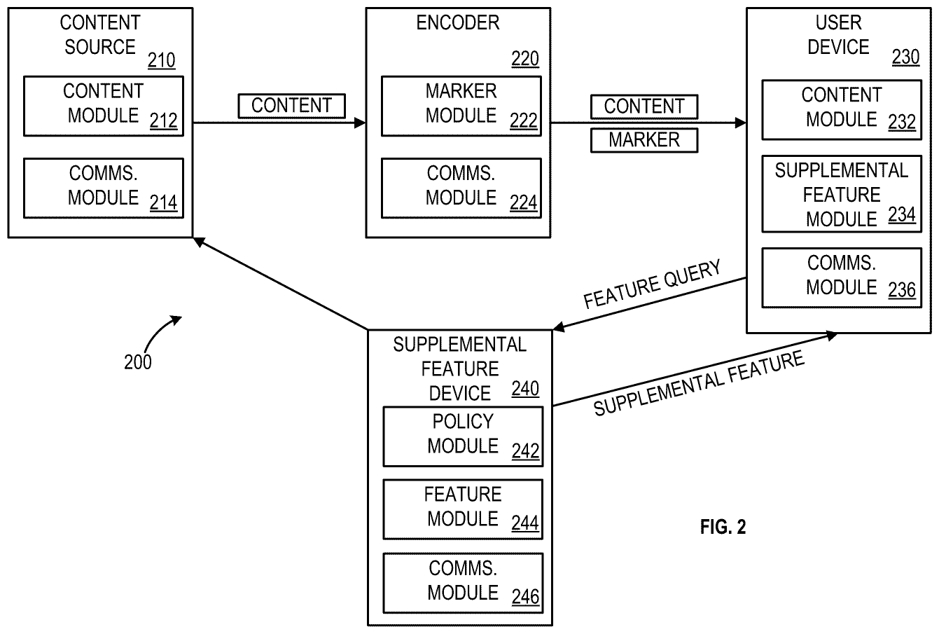

FIG. 2 shows an example system;

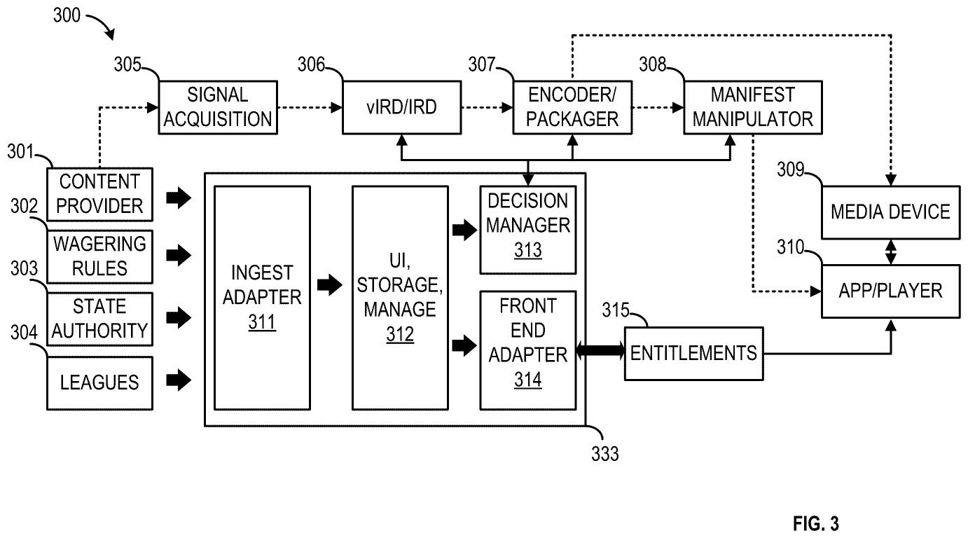

FIG. 3 shows an example system;

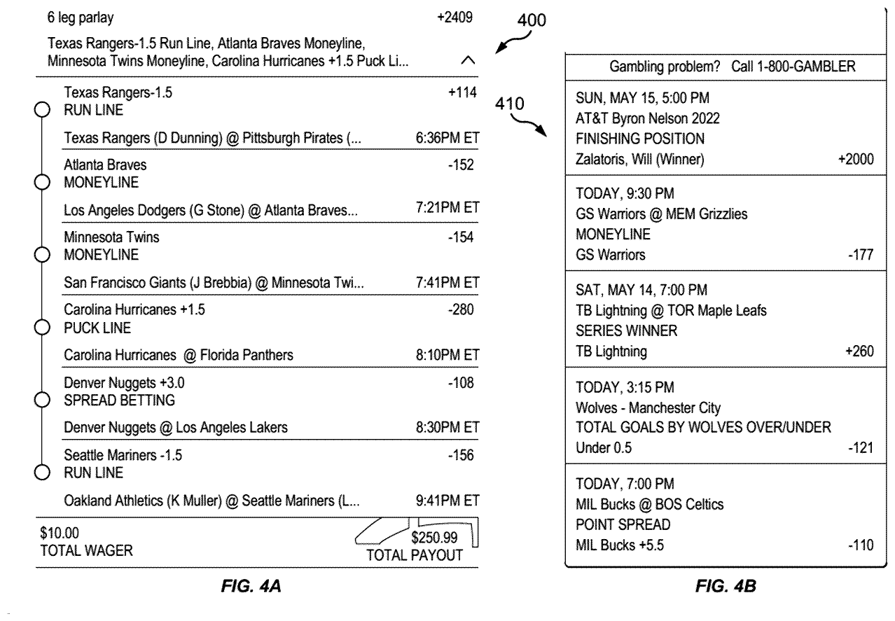

FIGS. 4A-4B show example interface wagering opportunities;

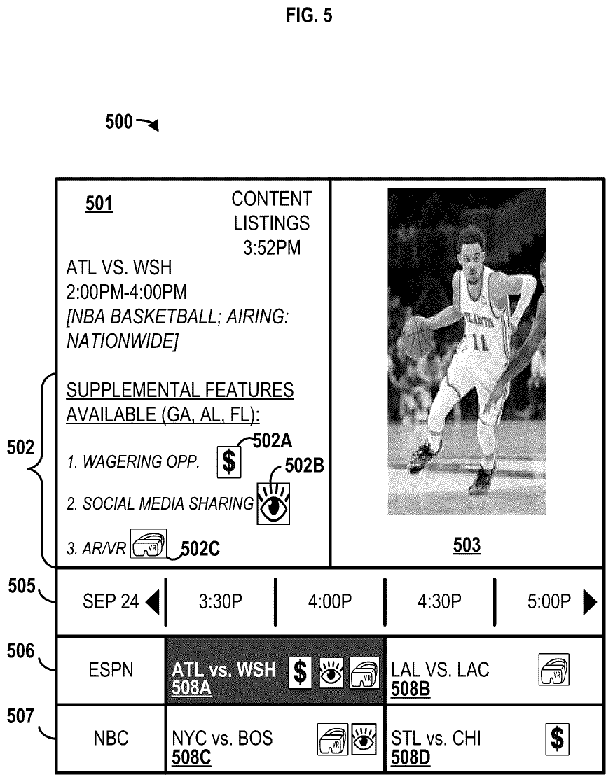

FIG. 5 shows an example user interface;

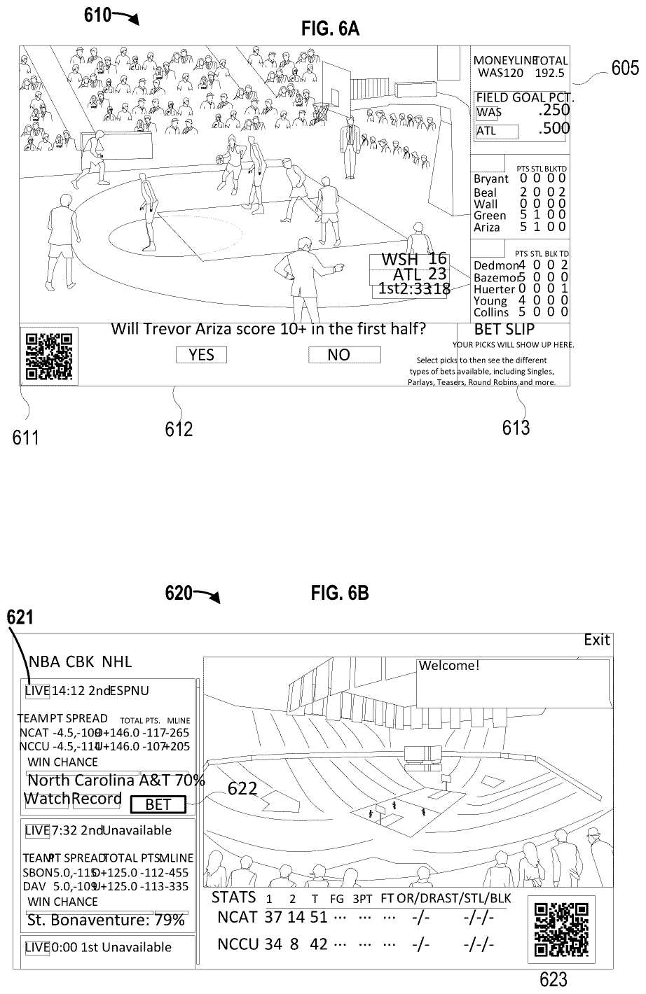

FIGS. 6A-6B show example user interfaces;

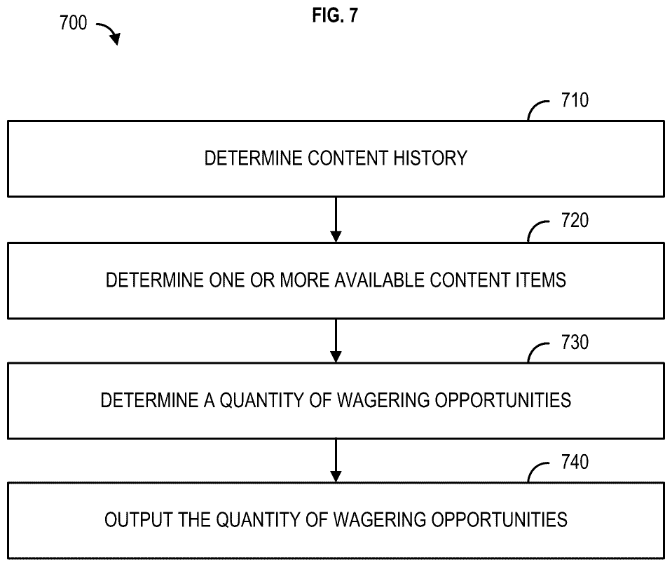

FIG. 7 shows an example method;

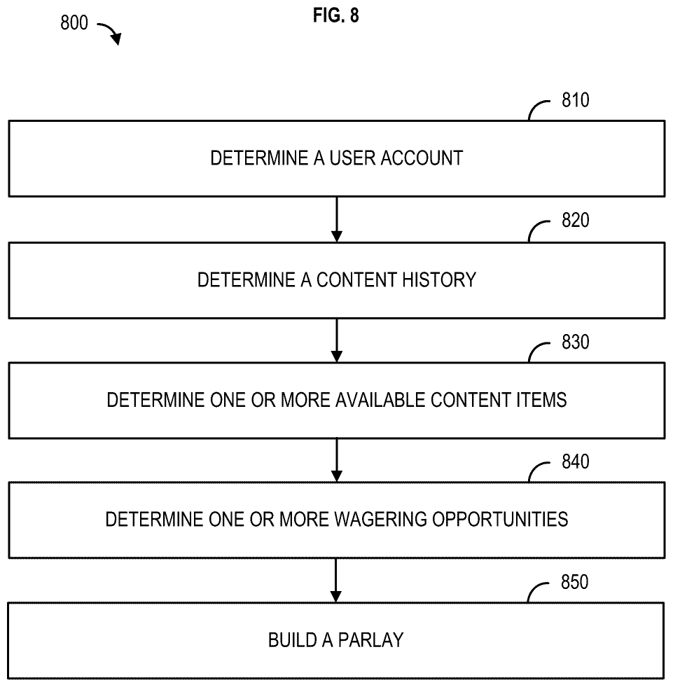

FIG. 8 shows an example method;

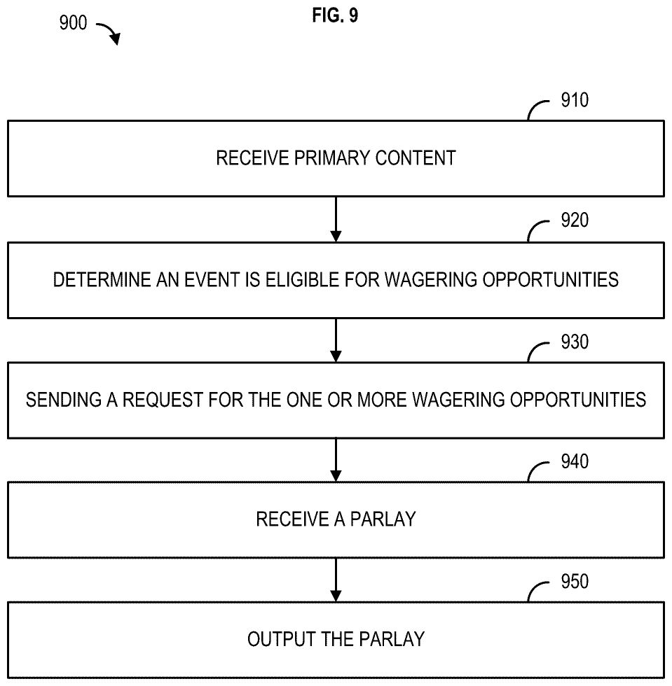

FIG. 9 shows an example method; and

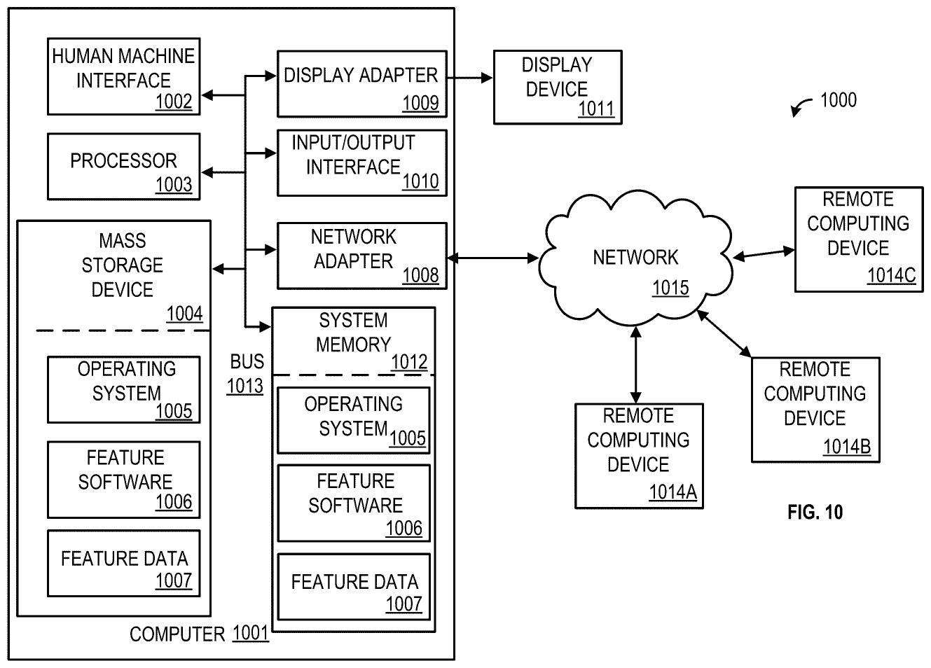

FIG. 10 shows an example system for content management.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. If such a range is expressed, another configuration includes from the one particular value and/or to the other particular value. Similarly, if values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is to be understood that if combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information.” Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic advertisement insertion data (.csv), Adobe® Photoshop® (.PSD) format or some other format for electronically storing text, graphics and/or other information whether such format is presently known or developed in the future. Content items may be any combination of the above-described formats.

This detailed description may refer to a given entity performing some action. It should be understood that this language may in some cases mean that a system (e.g., a computer) owned and/or controlled by the given entity is actually performing the action.

FIG. 1 shows a system 100 for content distribution. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise a content source 102, an encoder 104, a secondary content source 106, a supplemental feature source 108, a media device 120, and/or any of the other devices in FIG. 1, combinations thereof, and the like. Each of the content source 102, the encoder 104, the secondary content source 106, the supplemental feature source 108, and/or the media device 120 can be one or more computing devices, and some or all of the functions performed by these components may at times be performed by a single computing device. The content source 102, the encoder 104, the secondary content source 106, the supplemental feature source 108, and/or the media device 120 may be configured to communicate through a network 116. The network 116 may facilitate sending content from the content source 102 to the media device 120 (or other device) at a user location 119. The network 116 may facilitate sending advertisements from the secondary content source 106 to the media device 120 (or other device) at the user location 119. The network 116 may be a content delivery network, a content access network, combinations thereof, and the like. The network may be managed (e.g., deployed, serviced) by a content provider, a service provider, combinations thereof, and the like. The network 116 may be an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like.

The content source 102 may be configured to send content (e.g., video, audio, movies, television, games, applications, data, etc.) to one or more devices such as the encoder 104, a network component 129, a first access point 123, a mobile device 124, a second access point 125, the media device 120, the mobile device 124, or any other device of a content distribution network. The content source may receive a content request from, for example, the media device 120 and/or the encoder 104 (e.g., on behalf of the media device 120 or another device). The content source 102 may be configured to send streaming media, such as broadcast content, video on-demand content (e.g., VOD), content recordings, combinations thereof, and the like.

The content may comprise live content (e.g., “live programming”). “Live programming” may refer to, for example, television, internet, or radio content that is broadcast in real-time, as it is happening, without long delays (e.g., hours, days, weeks, etc. . . . ) between the event and its transmission to viewers or listeners. Live programming typically includes events, shows, or broadcasts that are happening in the present moment and are intended to be experienced by the audience as they occur. For example, most movies are not “live content,” but many sporting events, news broadcasts, talk shows, awards ceremonies, reality television, and gameshows, are broadcast as they occur. The content may comprise on-demand content (e.g., not “live programming”).

The content source 102 may be managed by third party content providers, service providers, online content providers, over-the-top content providers, combinations thereof, and the like. The content may be sent based on a subscription, individual item purchase or rental, combinations thereof, and the like. The content source 102 may be configured to send the content via a packet switched network path, such as via an IP based connection. The content may comprise a single content item, a portion of a content item (e.g., content fragment), a content stream, a multiplex that includes several content items, combinations thereof, and the like. The content may comprise one or more data packets. The content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like.

The content may comprise signaling data. The signaling data may include the one or more latency flags. The signaling data may be inserted into the content at the content source 102 or at the encoder 104. The signaling data may be inserted in a Moving Picture Experts Group (MPEG) bitstream, MPEG Supplemental Enhancement Information (SEI) messages, MPEG-2 Transport Stream (TS) packet, MPEG-2 Packetized Elementary Stream (PES) header data, ISO Base Media File Format (BMFF) data, ISO BMFF box, or any in any data packet. The signaling data may comprise one or more markers. For example, the signaling data may comprise Society of Cable and Television Engineers 35 (SCTE-35) markers and/or Society of Cable and Television Engineers 224 (SCTE-224) markers. The Society of Cable Telecommunications Engineers 35 (SCTE-35) and Society of Cable and Television Engineers 224 (SCTE-224) are hereby incorporated by reference in its entirety. The Society of Cable Telecommunications Engineers 30 (SCTE-30) and the Society of Cable Telecommunications Engineers 130 (SCTE-130) are also hereby incorporated by reference in their entirety.

The encoder 104 may receive the content. The encoder 104 may process the content and insert the one or more markers. The encoder 104 may generate a marker ID associated with the marker. The encoder 104 may generate the marker ID based on any parameter associated with the content, for example, a destination of the content. The encoder 104 may send, to the media device 120, marker and/or the marker ID. The marker may be sent to the media device 120 along with the content (e.g., from the content source 102). The marker may be sent to the media device 120 separate from the content. The marker may be sent to the media device 120 in a data packet. The marker ID may be inserted, by the encoder 104, into the SCTE-35 marker.

The content may be comprise or otherwise be associated with a content ID configured to identify the content. For example, the content may comprise one or more data packets, one or more content segments, or the like which may comprise the content ID. The content ID may be a string of characters, numbers, symbols, etc. The content ID may, for example, be a title or description of the content. The content may be associated with a content destination. The content destination may be any one or more devices of the system 100 or the like. For example, the content destination may be the media device 120. The content destination may be associated with a content destination ID. The content destination ID may be a MAC address or some other identifier associated with the one or more devices of system 100. For example, the content destination may be a MAC address or IP associated with the media device 120 and/or the second access point 125 (e.g., a headend or VDE). The content may comprise one or more data packets the one or more data packets may comprise one or more fields. The one or more fields may comprise a destination header configured to contain the destination ID.

For example, the content source 102 may receive a content request from the media device 120. The content request may comprise a device ID associated with the media device 120. The content source 102 may determine the device ID associated with the media device 120 is the destination ID and insert, into the destination field of the one or more data packets. Similarly, in another embodiment, the encoder or some other device may make a content request on behalf of the media device.

The media device 120 receive the content and determine the content ID. The media device 120 determine, based on the content ID, one or more policies associated with the content ID. For example, the one or more policies may comprise one or more timing policies, one or more location policies, one or more demographic policies, one or more subscription policies, one or more service level policies, combinations thereof, and the like. For example, the one or more policies may indicate that given user device (e.g., media device 120) is authorized to enable one or more supplemental features if one or more conditions are met.

The media device 120, the communication terminal, the access point 123, the mobile device 124, and/or the content source 102 may be configured to determine a content history (e.g., a content consumption history, content request history, content storage history, content subscription history, combinations thereof, and the like) associated with the media device 120. For example, the media device 120 may determine the content history associated with the media device 120 by virtue of recording and analyzing one or more outgoing requests for content, one or more incoming content segments, one or more user interactions with the media device, combinations thereof, and the like. The content history may comprise content consumption data. The content consumption data may indicate content consumed on the user device. The content consumption data may comprise information and metrics indicating, for example, when, and for how long, the media device 120 or mobile device 124 accessed content. For example, the content history may comprise a viewing history. For example, the content history may indicate a user account regularly tunes into certain St. Louis Cardinals baseball games, Atlanta Braves baseball games, Boston Celtics basketball games, PGA tour events, and UFC fights.

For example, the media device 120, the communications terminal 122, the access point 123, and/or the mobile device 124 may be configured to determine the content history based on internet browsing and/or social media activity. For example, the mobile device 124 may determine, by virtue of web traffic, that that a user associated with the mobile device 124 follows one or more teams or one or more athletes on social media. For example, the mobile device 124 may house one or more social media applications that may indicate a user account follows, likes, or subscribes to one or more social media accounts.

Based on receiving content, the media device 120 and/or the mobile device 124, for example, may send one or more feature queries to, for example, the supplemental feature source 108. The one or more feature queries may comprise one or more content identifiers (e.g., a title, a channel, a content identifier, combinations thereof, and the like). The one or more feature queries may comprise timing data (e.g., a time at which the one or more markers were received, a time at which the content was received, a time at which the content was output, a time at which the content was requested by the media device 120, combinations thereof, and the like). The one or more feature queries may comprise location information (e.g., a location of the media device 120 such as latitude and longitude, a geographic region, a syscode, a jurisdiction, combinations thereof, and the like). The one or more feature queries may comprise one or more user device identifiers. The one or more user device identifiers may be associated with the one or more user devices (e.g., the media device 120). For example, the one or more user device identifiers may comprise, for example, a unique string or characters, letters, numbers, symbols, etc. For example, the device identifier may comprise an OUI, a MAC address, an IP address, model number, a brand name, or any other identifier.

Based on receiving the one or more feature queries, the supplemental feature source 108 may send to the media device 120 and/or the mobile device 124, or otherwise cause those devices to activate or output, one or more supplemental features. The one or more supplemental features may comprise, for example, one or more applications, one or more websites, combinations thereof, and the like configured to facilitate a user taking advantage of the one or more supplemental features. For example, the one or more supplemental features may comprise one or more wagering opportunities.

The media device 120 may be configured to send a content output indication. The content output indication may comprise at least one of the marker ID, the marker timestamp, a media device ID, and/or a content ID, the location information, the timing data, and/or the one or more user device identifiers. The media device ID may comprise a unique identifier associated with the media device 120. For example, the media device ID may comprise a MAC address. The MAC address may be associated with a geographic ID (e.g., a “syscode”). The syscode may comprise a four digit code determined by National Cable Communications (NCC) to represent a specific geography available for advertisement insertion. The syscode may represent a specific geographic zone, grouping of zones, a cable interconnect or grouping of cable interconnects, combinations thereof, and the like. The content ID may comprise a unique ID associated with the content. For example, the content ID may comprise at least one of a channel ID, a frequency ID, a content title, a television network name, combinations thereof, and the like.

As shown in FIG. 1B, the media device 120 (and/or any applications, software, hardware thereon) may comprise a policy module 130, a location module 132, a timing module 134, and alternative content module 136. The media device 120 may determine, based on receiving the one or more feature queries an availability of one or more supplemental features for the media device 120. The availability of the one or more supplemental features may be determined based on the time delta.

The availability of the one or more supplemental features may be determined based on timing information and/or one or more policies. The timing module 134 may be configured to process timing information. The supplemental feature module 136 may be configured to activate or deactivate (e.g., block, grant access to, output, receive user inputs associated with) one or more supplemental features. The one or more supplemental features may comprise one or more interactive features. For example, the one or more supplemental features may comprise one or more wagering opportunities, one or more game show answer opportunities, one or more polling opportunities, combinations thereof, and the like as described herein. For example, the one or more supplemental features may comprise one or more wagering opportunities, one or more live statistics, one or more interactive features (e.g., quiz games, polling questions), closed-caption data, one or more shopping opportunities (e.g., purchase opportunities), combinations thereof, and the like.

The supplemental feature module 136 may be configured to receive, send, store, generate, determine, or otherwise process one or more supplemental features associated with the content (e.g., associated with the content history). For example, the supplemental feature module 136 may be configured to cause the media device to activate one or more supplemental content features. For example, the one or more supplemental content features may comprise one or more interactive features. For example, the one or more interactive features may comprise one or more wagering opportunities (e.g., one or more in-game betting features, one or more user interfaces configured to facilitate wagering on one or more content items), one or more audience polling features, one or more game show participation features, one or more reality tv features, one or more closed caption features, one or more content interaction features (e.g., one or more trick play features such as rewind, fast-forward, pause, record, volume change, or any change in content such as changing a resolution associated with content).

For example, the one or more supplemental features may be determined based on the content history. For example, one or more wagering opportunities may be determined based on the content history. For example, if the content history indicates the user tunes into almost any available NHL or NBA game, the methods described herein may determine one or more wagering opportunities associated with NHL games and NBA games. The content history may indicate a user regularly tunes into a certain team and thus one or more wagering opportunities associated with that team may be included in the one or more wagering opportunities. For example, the content history may indicate a user follows or likes one or more athletes and thus one or more wagering opportunities associated with the one or more athletes may be send to the media device 120 and/or the mobile device 124. For example, the one or more wagering opportunities may comprise one or more parlays associated with the content. A parlay may be a series or a sequence of wagers, where a successful first wager may be parlayed into a subsequent wager, and so on. For example, a parlay may comprise a cumulative series of bets in which winnings accruing from each transaction are used as a stake for a further bet. A parlay may comprise one or more wagering opportunities associated with one or more events (e.g., all wagering opportunities in the parlay need not be associated with the same event, though they may be). For example, if the primary content is an NBA game, the one or more parlays may comprise an over/under, a win/loss, one or more prop bets (e.g., proposition bets, wagers not tied to the final score or outcome of a contest), combinations thereof, and the like. The aforementioned are merely exemplary and are not intended to be limiting in any way. A person skilled in the art will understand that the one or more wagering opportunities may comprise any wagering opportunity.

The one or more wagering opportunities may be determined based on user preferences. The user preferences may be manually entered by a user, or learned over time by the system 100 by analyzing user behavior both in terms of content consumption and gambling activity. For example, the system, in the process of compiling a parlay, may determine a user has preference for certain types of wagers (e.g., line style betting such as money line, run line, puck line, spread betting, etc. . . . ). Thus, the quantity of wagering opportunities may include two run line wagering opportunities associated with teams the user regularly views, two money line wagering opportunities, one puck line wagering opportunity (if the user likes hockey), and one spread betting opportunity. Similarly, the system may learn a risk tolerance preference associated with a user account. For example, the system may learn that user does not ever wager on a parlay with odds greater than +3000. Thus, the system may compile a parlay such that the total odds are less than +3000.

For example, a first policy of the one or more policies may relate to in-game betting associated with content while a second policy of the one or more policies may relate to content blackouts in one or more geographic regions. The one or more policies may be associated with one or more user device identifiers, one or more content identifiers, one or more geographic regions, one or more time periods, one or more demographic profiles (e.g., age ranges), combinations thereof, and the like.

The policy module 130 may be configured to store one or more content policies. The one or more content policies may comprise, for example, a content gaming policy. The one or more content policies may be configured to indicate one or more geographic regions, one or more user devices, one or more content items, one or more rules/regulations, combinations thereof, and the like associated with one or more supplemental content features. The one or more supplemental content features may comprise one or more interactive content features. For example, the one or more content policies may comprise geographic content output data, subscription output data, timing output data, blackout data, combinations thereof, and the like. For example, the one or more policies may indicate that the content is associated with one or more supplemental features. For example, the one or more policies may indicate the one or more supplemental features are associated with one or more geographic regions. The policy module 130 may determine a violation of the one or more content policies. For example, the policy module 130 may receive a feature query. The policy module 130 may determine one or more of the location information in the feature query, the user device identifier in the feature query, or other information in the feature query. The policy module 130 may compare, for example, the location information and the user device identifier to a supplemental feature policy. The supplemental feature policy may indicate that one or more supplemental features are authorized in a first geographic region. The location information in the content output indication may indicate the user device is located in the first geographic region. As such, the policy module 130 may determine the user device in the first geographic region may receive/execute/generate/or otherwise process one or more supplemental features.

The location module 132 may be configured to process the location data in the feature query. The location module 132 may be configured to determine whether the location information in the feature query complies with a content policy stored in the policy module 130. For example, the location module 132 may determine the location information in the feature indicates a second geographic region. The location module may query the policy module 136 to determine whether the second geographic region is listed on the content policy as a geographic region where the supplemental feature is authorized or not. For example, the location module may determine the second geographic region is a region where the supplemental feature is not authorized.

For example, the supplemental feature module 136 may be configured to send and/or receive one or more SCTE-224 message configured to activate an application (e.g., a gambling application) on the media device 120. Additionally and/or alternatively, the supplemental feature module 136 may be configured to cause the media device 120 to download one or more software applications configured to facilitate one more user interactions with the content.

Returning to the components of system 100, the network 116 may comprise a network component 129. The network component 129 may be any device, module, combinations thereof, and the like communicatively coupled to the network 116. The network component 129 may also be a router, a switch, a splitter, a packager, a gateway, an encoder, a storage device, a multiplexer, a network access location (e.g., tap), physical link, combinations thereof, and the like.

The media device 120 may comprise a demodulator, decoder, frequency tuner, combinations thereof, and the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the communication terminal 122, a computer, a TV, a monitor, or a satellite dish. The communication terminal 122 may be located at the user location 119. The communication terminal 122 may be configured to communicate with the network 116. The communication terminal 122 may be a modem (e.g., cable modem), a router, a gateway, a switch, a network terminal (e.g., optical network unit), combinations thereof, and the like. The communication terminal 122 may be configured for communication with the network 116 via a variety of protocols, such as IP, transmission control protocol, file transfer protocol, session initiation protocol, voice over IP (e.g., VOIP), combinations thereof, and the like. The communication terminal 122, for a cable network, may be configured to facilitate network access via a variety of communication protocols and standards, such as Data Over Cable Service Interface Specification (DOCSIS).

A first access point 123 (e.g., a wireless access point) may be located at the user location 119. The first access point 123 may be configured to provide one or more wireless networks in at least a portion of the user location 119. The first access point 123 may be configured to facilitate access to the network 116 to devices configured with a compatible wireless radio, such as a mobile device 124, the media device 120, the display device 121, or other computing devices (e.g., laptops, sensor devices, security devices). The first access point 123 may be associated with a user managed network (e.g., local area network), a service provider managed network (e.g., public network for users of the service provider), combinations thereof, and the like. It should be noted that in some configurations, some or all of the first access point 123, the communication terminal 122, the media device 120, and the display device 121 may be implemented as a single device.

The user location 119 is not necessarily fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, combinations thereof, and the like. The mobile device 124 may communicate with a variety of access points (e.g., at different times and locations or simultaneously if within range of multiple access points), such as the first access point 123 or the second access point 125.

FIG. 2 shows an example system 200. The system 200 may comprise a content source 210 (e.g., the content source 102), an encoder 220 (e.g., the encoder 104), a user device 230 (e.g., the media device 120, and/or the mobile device 124), and a policy device 240 (e.g., the rights management device 106). The content source 210 may send content to the encoder 220. The encoder 220 may receive the content and insert, into the content, one or more markers. The one or more markers may comprise one or more beacons configured to cause the user device 230 to send, to the supplemental feature device 240, one or more supplemental feature queries.

The content source 210 may comprise a content module 212 and a communications module 214. The communications module 214 may be configured to receive, send, store, generate, or otherwise process data. The content module 212 may be configured to receive, send, store, generate, or otherwise process content. For example, the content source 210 may be configured to send content stored in the content module 212. The content module 212 may receive live content (e.g., from a content feed (not pictured)). For example, the content feed may be a camera configured to capture image data and generate a camera feed (e.g., the live content or live programming). The content source 210 may be a computing device configured to receive the camera feed and process it for distribution. For example, the content source 210 may send the content to the encoder 220.

The encoder 220 may receive the content. The encoder 220 may comprise a marker module 222 and a communications module 224. The communications module 224 may be configured to receive, send, store, generate, or otherwise process data. The marker module 222 may be configured to insert, into the content, one or more markers. The one or more markers may comprise, for example, one or more SCTE-35 markers and/or one or more SCTE-224 markers. The encoder 220 may send the content and the one or more markers to the user device 230. The one or more markers may comprise one or more beacons configured to cause the user device 230 to take one or more actions (e.g., to send one or more feature queries).

The user device 230 may receive the content and the one or more markers. For example, the user device 230 may comprise a set-top-box (STB), a mobile device (e.g., a smartphone), a smart TV, a computer, a laptop, combinations thereof, and the like. The user device 230 may comprise a content module 232, a supplemental feature module 234, and a communication module 236. The communications module 236 may be configured to receive, send, store, generate, or otherwise process data. The content module 232 may be configured to receive, send, store, generate, or otherwise process content. The content module 232 may be configured to output the content. For example, the user device 230 may be configured to cause display of the content via a display device. The user device 230 may comprise the display device and/or the display device may be separate from the user device 230. The user device 230 may receive the content and determine the one or more markers. Based on determining the one or more markers, the user device may send one or more feature queries. For example, the user device may receive a SCTE-35 marker and may send the one or more feature queries. For example, the user device may send the one or more feature queries via a SCTE-224 signal (e.g., an out-of-band signal). For example, the user device 230 may receive the SCTE-35 marker and may send, via a SCTE-244 or SCTE-250 message, the one or more feature queries. Similarly, an upstream device may receive the SCTE-35 marker and may implement (e.g., enforce) a policy for one or more downstream devices. The one or more feature queries may comprise, for example, one or more user device identifiers associated with the user device, location data associated with the user device, timing data associated with the content and/or timing data associated with the one or more markers (e.g., a time at which the user device received the content, a time at which the user device output the content, a time at which the user device received the one or more markers). The one or more feature queries may comprise location data associated with the content and/or location data associated with the user device 230. For example, the location data associated with the content may indicate a geographic location within which the content is to be distributed. The location data may indicate a geographic region within which the content originated (e.g., a live-feed). The one or more feature queries may comprise one or more content identifiers such as a title, channel, production company, copyright owner, distributor, content source, combinations thereof, and the like.

The user device 230 may send the one or more feature queries to the supplemental feature device 240. The supplemental feature device 240 may comprise the rights management device 106 (e.g., a linear rights management (LRM) device) and/or the supplemental feature source 108 of FIG. 1. The supplemental feature device may comprise a policy module 242, a feature module 244, and a communications module 246. The communications module 246 may be configured to receive, send, store, generate, or otherwise process data. The supplemental feature device 240 may determine, based on the one or more feature queries, one or more supplemental features to make available to the user device 230. Additionally and/or alternatively, the supplemental feature device 240 may determine that no supplemental features are available to the user device 230. For example, the policy module 242 may be configured to store one or more policies and determine whether the one or more policies are applicable to the content sent to the user device and/or applicable to the user device 230.

The one or more policies may comprise policy location information (e.g., a geographic region or other location where a given policy is or is not applicable), an applicability indication (e.g., applicable, not applicable), timing information (e.g., one or more policy start times, one or more policy end times), content information (e.g., one or more content titles, one or more content sources, one or more channels, one or more frequencies, one or more copyright owners, one or more distribution rights, one or more content locators such as a uniform resource locator (URL), combinations thereof, and the like). The one or more policies may indicate one or more rules (e.g., rules, regulations, laws, etc.) associated with one or more geographic regions (e.g., one or more jurisdictions). For example, a first piece of content may comprise a sports game (e.g., a live broadcast of an NBA game) and a first policy of the one or more policies may indicate gambling on the first piece of content is allowed in a first jurisdiction associated with a first user device while gambling on the first piece of content is not allowed in a second jurisdiction associated with a second user device. The one or more policies may indicate trick play (e.g., fast-forward) of the content is allowed in a first geographic region but not allowed in a second geographic region, or allowed for a first group of user devices but not for a second group of user devices.

The feature module 244 may be configured to send and receive supplemental feature data to and from the user device 230 and/or any other device of FIGS. 1A-1B, FIG. 2, FIG. 3, and/or FIG. 7. The feature module may send, based on determining a policy applies to the user device 230, one or more supplemental features messages to the user device 230. The one or more supplemental feature messages may be configured to cause the user device to activate one or more supplemental features (e.g., via the supplemental feature module 234). The one or more supplemental feature messages may comprise one or more SCTE-224 messages. The one or more supplemental features may comprise, for example, one or more functionalities associated with the content. The one or more functionalities may comprise for example, one or more gaming functionalities, one or more social media functionalities, one or more transactional functionalities such as making purchases, one or more content functionalities such as one or more trick play functionalities, one or more recording functionalities, one or more editing functionalities, combinations thereof, and the like.

For example, the user device 230 may send the one or more feature queries to the supplemental feature device 240. Based on the information in the one or more feature queries, the supplemental feature device 240 may determine the user device is located in Las Vegas Nevada and is receiving and/or outputting an Atlanta Hawks NBA game. The supplemental feature device 240 may determine, based on the one or more policies, that gambling on the Atlanta Hawks game is allowed in Las Vegas. Based on determining that gambling on the Atlanta Hawks game is allowed in Las Vegas, the feature module 244 may send a first supplemental feature message to the user device 230. The first supplemental feature message may be configured to cause the user device to launch a gambling applet (e.g., via the supplemental feature module 234) on the user device 230. The gambling applet may be configured to send and receive data. For example, the gambling applet may be configured to receive and display information related to the Atlanta Hawks game. The gambling applet may be configured to receive one or more user inputs and send and receive one or more subsequent supplemental feature messages based thereon. For example, the gambling applet may display odds related to the Atlanta Hawks game and may receive one or more wagers via a user interface associated with the gambling applet. The supplemental feature module may send the one or more wagers to the supplemental feature device where they may be processed by the feature module 244.

FIG. 3 shows an example system 300. The system 300 may comprise a content provider 301, a wagering rules database 302, a state authority database 303, a leagues database 304, a signal acquisition device 305, a virtual integrated receiver-decoder/integrated receiver-decoder (vIRD/IRD) 306, and encoder/packager 307, a manifest manipulator 308, a media device 309 (e.g., a set-top-box, the media device 120/the user device 230, etc.), an application/player 310, a linear rights manager (LRM) 333 comprising an ingest adapter 311, a UI, storage, and manage module 312, a decision manager 313, a front-end adapter 314, and an entitlements database 315. The components of the system may be configured to be in communication through a network such as the network 116. The LRM 333 may be an upstream device or a downstream device.

In operation, any one or more of the content provider 301, the wagering rules database 302 (e.g., a gaming authority such as the Nevada Gaming Control Board or any other similar authority), the state authority database 303 (e.g., a state legislature or other body), any one or more leagues databases 304 or wagering organizations may provide rules to the ingest adapter 311. For example, the one or more rules may comprise an indication whether or not a jurisdiction, league, organization, etc allows wagering, if a wagering window is only available during this time period, if wagering is only allowed for a specific age group, device, jurisdiction, subscription level, etc. In operation, content providers may send video (and/or other data) for distribution to consumers (e.g., the media device 309).

The LRM 333 may receive one or more content histories from the content provider and/or the media device 309. The LRM 333 may aggregate and ingest the one or more policies, and convert them into an event schedule notification interface (ESNI) or digital rights management (DRM) standard configured to apply the one or more policies. For example, the LRM 333 may ingest a gambling policy associated with an NBA basketball game and convert the gambling policy to the SCTE-224 format. The LRM 333 may store the aggregated rules in storage (e.g., cloud storage). The decision manager 313 may determine the one or more SCTE-35 markers in the content and may determine to apply one or more rules based on the content ID and/or the destination ID. The decision manager 313 may trigger the one or more supplemental features (e.g., a user interface overlay to be displayed over the content, wherein the user interface overlay is configured to facilitate placing wagers on an underlying gaming event). The LRM 333 may be configured to aggregate the one or more policies and, in response to a query from the encoder/packager 307 comprising the content ID and/or the destination ID, determine one or more supplemental features associated with the content and/or the destination (e.g., restriction information). The LRM 333 may send the restriction information indicating the one or more supplemental features (and/or the availability or non-availability thereof) to the encoder/packager 307. The encoder/packager 307 may, based on the restriction information, encode supplemental feature signaling data into the outbound stream bound for the destination. For example, by taking the gaming data from all the source inputs (League, Location, Gaming Authorities, etc.), converting this data into a SCTE-224 metadata feed (e.g., one or more SCTE-224 markers) and then integrating that SCTE-224 metadata feed into an outbound stream (e.g., the transport stream), key stakeholders such as content providers and other services may activate an in-game betting pop-up/applet/layover/functionality. Thus, at the start of a wagering event, a SCTE-224 Decision Engine (e.g., the decision manager 313) may respond with the playout rights, to include if wagering is allowed or not based on the destination ID, the content ID, local rules, etc. If wagering is allowed, the player may a flag as wagering allowed which may trigger one or more actions behalf of the media device 309. For example, the media device 309 may send one or more content histories, one or more queries, or the like, to determine, for example, which wagering opportunities to include in a parlay. So if the user clicks on the in-gaming betting app the player knows that it can present an in-game betting application to the user.

For example, the one or more SCTE-224 markers may be configured to cause the media device 120 to launch one or more applications. The one or more applications may be associated with the one or more supplemental features. The media device 120 may launch the one or more applications based on receipt of the one or more SCTE-224 markers. For example, the one or more SCTE-224 markers may comprise one or more supplemental feature indicators in one or more fields of the one or more SCTE-224 markers. The one or more supplemental feature indicators may indicate one or more applications associated with the underlying content, subscription information associated with the underlying content, one or more device types, location information, or the like. The media device 120 may, for example, based on the one or more applications associated with the underlying content identified in the SCTE-224 marker, determine if an application of the one or more applications is currently installed on, or otherwise available to (e.g., via download or web interface by virtue of a subscription) the media device 120. If so, the media device 120 may launch (or prompt a user to launch) the application. As described in greater detail with respect to FIGS. 4-5B, the application may comprise an overlay or other interface configured to display data associated with the underlying content (e.g., gambling data) and receive one or more user inputs. (e.g., by virtue of other data which may identify an application associated with a supplemental feature.

Additionally and/or alternatively, LRM 333 could determine at the moment a user tries to access the in-game betting pop-up (e.g., based on a received user input), whether that user device (e.g., based on location, class of device, subscription information etc. . . . ) is allowed to access the pop-up. Additionally and/or alternatively, beacon technology may be incorporated to auto-correct or provide real-time audit capabilities to ensure the betting rules are being enforced. For example, when there is content eligible for betting available, a beacon may be added to the playout instructions in a similar fashion to an ad beacon at the start of the ad (e.g., in the or more SCTE-35 markers). The beacon may be configured to trigger a beacon call a beacon call. Likewise, anyone not watching the content, (i.e., they are on slate or alternate content), does not trigger a beacon call and therefore it may be determined that user device is adhering to the policy. In this manner, one or more beacons may be collected and analyzed (e.g., compared against device restriction and a policy footprint determine if anyone is watching gaming content in violation of the policy). The one or more beacon calls may comprise information about the content, a location associated with the media device, an output indication, one or more feature queries, an impression count, combinations thereof, and the like. The one or more beacon calls may comprise one or more output indications. The one or more output indications may comprise one or more content identifiers (e.g., a title, a channel, a content identifier, combinations thereof, and the like). The one or more output indications may comprise timing data (e.g., a time at which the one or more markers were received, a time at which the content was received, a time at which the content was output, a time at which the content was requested by the media device 120, combinations thereof, and the like). The one or more content output indications may comprise location information (e.g., a location of the media device 120 such as latitude and longitude, a geographic region, a syscode, a jurisdiction, combinations thereof, and the like). The one or more output indications may comprise one or more user device identifiers. The one or more user device identifiers may be associated with the one or more user devices (e.g., the media device 120). For example, the one or more user device identifiers may comprise, for example, a unique string or characters, letters, numbers, symbols, etc. For example, the device identifier may comprise an OUI, a MAC address, an IP address, model number, a brand name, or any other identifier.

FIGS. 4A and 4B show examples of how gaming and/or wagering opportunities can be analyzed and determined. FIG. 4A and FIG. 4B both show gaming and wagering opportunities such as parlays, but a person skilled in the art will appreciate that the one or more wagering opportunities may comprise any type or form of wagering opportunities (e.g. single bets). A parlay may be a series or a sequence of wagers, where a successful first wager may be parlayed into a subsequent wager, and so on. For example, a parlay may comprise a cumulative series of bets in which winnings accruing from each transaction are used as a stake for a further bet For example, FIG. 4A shows data for one or more wagering opportunities 400. For example, FIG. 4B shows data for one or more wagering opportunities 410. The one or more wagering opportunities 400 and 410 may comprise all of the wagering opportunities associated with a content engagement and consumption history of a user. The one or more wagering opportunities 400 and 410 may, on the other hand, comprise a portion of the total wagering opportunities currently available to the user.

Referring to FIG. 4A, a quantity of wagering opportunities 400 is shown. The quantity of wagering opportunities 400 may be determined based on a content engagement or consumption history, selected favorites, environmental and premises related data, restrictions or entitlements, live game schedules, real time tuning behavior, subscription information, jurisdictional or location based policies, combinations thereof, and the like. For example, the quantity of wagering opportunities 400 shown in FIG. 4A may be determined based on a user's content consumption history. It may be determined that the user regularly tunes into Texas Rangers games, Minnesota Twins games, and Seattle Mariners games. It may also be determined the user regularly consumes any available NBA games and any available NHL games, and also lives in Atlanta.

Thus, the quantity of wagering opportunities may comprise a wagering opportunity associated with a Texas Rangers game, a wagering opportunity associated with a Minnesota Twins game, and a wagering opportunity associated with a Seattle Mariners game. Further, because the user is determined to live in Atlanta (e.g., by virtue of location information associated with one or more of the media device 120 and/or the mobile device 124), the methods described herein may include a wagering opportunity associated with the Atlanta Braves in the quantity of wagering opportunities. Further, because the content history indicates the user tunes into almost any available NHL or NBA game, the methods described herein may determine a wagering opportunity associated with an NHL game (e.g., the Carolina Hurricanes) and a wagering opportunity associated with an NBA game (e.g., the Denver Nuggets) and includes these wagering opportunities in the quantity of wagering opportunities 400. The wagering opportunities associated with the NHL game and the NBA game may be included because their respective start times are within a threshold amount of time (e.g., one or two hours) of other wagering opportunities included in the quantity of wagering opportunities 400.

The quantity of wagering opportunities 400 may be determined based on user preferences. The user preferences may be manually entered by a user, or learned over time by the system 100 by analyzing user behavior both in terms of content consumption and gambling activity. For example, the system may, in the process of compiling the parlay shown in FIG. 4A, may determine a user has preference for certain types of wagers (e.g., line style betting such as money line, run line, puck line, spread betting, etc. . . . ). Thus, the quantity of wagering opportunities 400 includes two run line wagering opportunities (Texas Rangers and Seattle Mariners), two money line wagering opportunities (Atlanta Braves and Minnesota Twins), one puck line wagering opportunity (Carolina Hurricanes), and one spread betting opportunity (Denver Nuggets). Similarly, the system may learn a risk tolerance preference associated with a user account. For example, the system may learn that user does not ever wager on a parlay with odds greater than +3000. Thus, the system may compile a parlay such that the total odds are less than +3000 (e.g., as seen in FIG. 4A, the total odds of the parlay hitting are +2409).

Referring to FIG. 4B, a quantity of wagering opportunities 410 is shown. The quantity of wagering opportunities 410 is different from the quantity of wagering opportunities 400 shown in FIG. 4A because the content history of the user for whom the parlay shown in 410 is compiled is different than the content history of the user for whom the parlay shown in 400 is compile. For example, the quantity of wagering opportunities 410 includes a golf event and a European football (soccer) event. The risk tolerance of the user associated with the quantity of wagering opportunities 410 (+41,386) is also much higher than the risk tolerance of the user associated with the quantity of wagering opportunities 400.

The quantity of wagering opportunities may be determined based on internet traffic associated with the premises 119. For example, the CT 122 or other device may determine a user associated with the premises follows Will Zalatoris on social media (e.g., INSTAGRAM, FACEBOOK, ETC. . . . ). Thus, one or more wagering opportunities associated with Will Zalatoris may be determined and included in the parlay. Similarly, it may be determined that a user associated with a premises recently purchased a Manchester City jersey and thus, one or more wagering opportunities associated with Manchester City may be included in the parlay. Thus, a person skilled in the art will appreciate that any web traffic may be used to determine the one or more wagering opportunities. A parlay may be a series or a sequence of wagers, where a successful first wager may be parlayed into a subsequent wager, and so on. For example, a parlay may comprise a cumulative series of bets in which winnings accruing from each transaction are used as a stake for a further bet

FIG. 5 shows an example interface 500. The example interface 500 may comprise an electronic program guide, content guide, menu, another similar interface, combinations thereof, and the like. An electronic program guide is commonly referred to as an EPG. The EPG may display a schedule of available programs, allowing users to navigate through channels, view program descriptions, and select shows to watch or record. The interface 500 may be configured to indicate one or more supplemental features associated with one or more content items. For example, EPG data may be sent to a receiving device (e.g., the media device 120 and/or the mobile device 124). The EPG data may be sent in a broadcast signal (in the case of traditional television) or delivered over the internet (for IPTV, streaming services, digital platforms, combinations thereof, and the like). Broadcasters or service providers send the EPG data to the receiving devices or set-top boxes through dedicated channels or data streams.

The receiving device (e.g., the media device 120 and/or the mobile device 124) may parse the EPG data. For example, the receiving devices or set-top boxes may receive the EPG data and may parse the EPG data into a usable format. The parsed data EPG data may be stored locally on the device or in a dedicated memory space. Based on the parsed EPG data, the media device 120 may send one or more supplemental feature queries. For example, the media device may determine the parsed EPG data comprises one or more sporting events. The media device may send a query to, for example, the supplemental feature source (or sources) 108 to determine if one or more supplemental features (e.g., one or more wagering opportunities) associated with any of the content in the EPG data.

The interface 500 may comprise one or more fields, panes, areas, etc. The one or more fields may comprise, for example, a first field 501, a second field 503, one or more timing fields 505, one or more source fields 506 and 507, and one or more content fields 508A-D associated with one or more content items. The one or more timing fields 505 may be configured to indicate when content is available (e.g., airing or otherwise available or accessible to a user). For example, the one or more timing fields may indicate a start time, duration, end time, combinations thereof, and the like associated with available content items. The timing field 505 indicates content that may be available today, tomorrow, next week, or any time in the future. The one or more channel indicators 506 and 507 may be configured to indicate a channel or other means of accessing the available content. For example, channel indicator 506 indicates content available on ESPN while channel indicator 507 indicates content available on NBC. The one or more timing indicators 505 and the one or more channel indicators 506 and 507 may be dynamic (e.g., updated as time and content offerings change). The interface 500 may be configured as a navigable interface configured to receive one or more user inputs and update, based on the one or more user inputs, an output associated with the interface. For example, the interface 500 may be configured as a navigable menu wherein the navigable menu displays available content and may be configured to receive a selection of a content item of the available content from the user, via the user device. Based on the user input, the interface 500 may be updated to output information about the selected content. For example, in FIG. 5, a content item associated with content field 508A has been selected (as indicated by a variance in color, however, the indication may be represented in any manner).

The first field 501 may be configured to display primary content data associated with the selected content and supplemental feature data 502 associated with selected content. The primary content data may comprise information such as a title or subject matter associated with the selected content. For example, the first field 501 indicates The primary content data may indicate a title, subject matter, air time (or any other availability), content source, content owner, combinations thereof, and the like. For example, the first field 501 indicates an NBA Basketball game between the Atlanta Falcons and Washington Wizards is airing nationwide. The second field 503 may be configured to output (e.g., display) additional data associated with the selected content item. For example, the second field 503 in FIG. 5 shows an image of an NBA basketball player on the Atlanta Hawks. The second field 503 may output a video preview, one or more still images, one or more thumbnails, the actual selected content, one or more hyperlinks associated with the selected content, combinations thereof, and the like.

The supplemental feature data 502 may indicate one or more supplemental features associated with the content. For example, the supplemental feature data 502 indicates the Atlanta vs. Washington game is associated with one or more wagering opportunities, social media sharing, and AR/VR enhancement. The supplemental feature data 502 may indicate one or more supplemental feature icons 502A-D. The one or more supplemental feature icons 502A-D may correspond to or otherwise be associated with one or more supplemental features and may be output on the interface 500 (e.g., in the area indicated by 502, the one or more fields indicating the one or more available content items, etc. . . . ). For example, content item 508A ATL vs. WSH (the Atlanta Hawks vs. Washington Wizards), is associated with three icons (in-game betting, social media sharing, and AR/VR), while the LAL vs. LAC (Las Angeles Lakers vs. Las Angeles Clippers) game (associated with field 508B) is associated with only the AR/VR icon, NYC vs. BOS is associated with the AR/VR icon and the social media sharing icon, while a sporting event featuring teams from St. Louis and Chicago is associated only with in-game betting (as indicated by the dollar sign). The supplemental feature data 502 may indicate one or more geographic regions associated with the one or more supplemental features. The one or more geographic regions may indicate where the one or more supplemental features are available and whether or not the one or more supplemental features are where the user is (e.g., by virtue of where a set-top-box, user device, or any other device is located).

FIGS. 6A-6B show example displays 610 and 620. Displays 610 and 620 show both content and the one or more supplemental features. For example, display 610 is displaying, as primary content, the Atlanta vs. Washington NBA Basketball game. The display may display any information associated with the content being output such as one or more player lineups, field goal percentages, and/or any other data associated with the primary content (e.g., statistical information associated with a sporting event). The display 610 may be configured to output one or more applications (e.g., applets, widgets, etc. . . . ) associated with the one or more supplemental features. For example, upon receiving the content and/or the supplemental features, the media device 120 may cause an application to launch. The application may be configured to output one or more interactive user interfaces. For example, the QR code 611 is an interactive interface. The QR code 611 may be scannable by an AR/VR device and thereby facilitate the provision of the AR/VR supplemental feature. Similarly, the interface 612 is an interactive interface. For example, the interface 612 outputs (e.g., the application outputs) one or more selectable options (e.g., “YES” and “NO”) associated with one or more wagering opportunities. The betting application may be configured to facilitate in-game betting during sporting events. Similarly, the interface 610 shows a moneyline associated with the game 613 and a bet slip 614 which may display bets a user has placed and information associated therewith.

The display 620 in FIG. 6B also shows primary content and one or more supplemental features. The primary content in FIG. 6B is also basketball. The display 620 comprises a wagering interface 621 is configured to display one or more wagering opportunities associated with content such as one or more parlays wherein one or more legs of the parlay is associated with content being out, one or more point spreads, one or more moneylines, one or more win percentages associated therewith as well as a win percentage 622 configured to indicate how likely a given team is to win. A parlay may be a series or a sequence of wagers, where a successful first wager may be parlayed into a subsequent wager, and so on. For example, a parlay may comprise a cumulative series of bets in which winnings accruing from each transaction are used as a stake for a further bet. The wagering interface 621 comprises a bet button 622. The bet button 622 may be configured as a selectable option which a user may select (via a user device such as a remote control or a smart phone configured with a complimentary application). For example, selecting the bet button may launch an applet on the interface 620. The interface 620 also shows a QR code 623. The QR code 623 may be configured to cause a user device such as a smart phone to launch one or more applications. FIGS. 6A-6B show sports content but could it is to be appreciated the content could be any type of content including movies, television shows, public addresses, advertising, combinations thereof, and the like.

FIG. 7 shows a flowchart of a method 700. The method 700 may be carried out on any one or more of the devices described in FIGS. 1A-1B, FIG. 2, FIG. 3, and/or FIG. 10. At 710, a content history associated with a user may be determined. The content history may comprise or otherwise indicate a historical record of content consumed by a user (e.g., content sent to, recorded by, output by, etc. . . . ) a user device such as the media device 120 and/or the mobile device 124. The content history may be determined based on user credentials. For example, a user may login, or the user's identity may be determined other ways (e.g., facial recognition, etc. . . . ). The content history may be determined based on a current content consumption pattern that matches a content consumption of a user account.

The content history may include titles, names, or other identifiers of content, duration of length of content, one or more timestamps (e.g., a time at which a user started viewing content, a time at which a user stopped viewing the content), frequency of viewing, duration of viewing content, playback progress data, ratings and other feedback, device information (e.g., an identifier associated with a device on which the content viewed), platform information (e.g., an application or streaming platform on which the content was viewed), viewing habits, viewing patterns, combinations thereof, and the like.

At 720, one or more available content items may be determined. The one or more available content items may be associated with one or more wagering opportunities. The one or more available content items may be determined based on the content history. The one or more available content items may be determined because they are associated with the content history. For example, the one or more available content items may have information (e.g., metadata) in common with one or more content items in the content history. For example, the content history may indicate the media device 120 accessed (e.g., requested, received, output, etc. . . . ) St. Louis Cardinal baseball games, one or more Atlanta Braves games, one or more Celtics games, one or more PGA tour events, and/or UFC fights. The strength of association between the one or more available content items may vary. For example, duration of viewing of a content item may influence how that content item is used in determining the one or more available content items. For example, content items in the content history that were viewed for longer durations or constitute relatively higher percentages of total viewing time may be weighted more heavily than content items that are only viewed briefly or infrequently (e.g., irregularly). Similarly recorded content items may be weighted heavily because a user recording a content item may indicate it is important to the user. Conversely, content items that were only viewed briefly, or infrequently may be lightly weighted.

At 730, a quantity of wagering opportunities of the one or more wagering opportunities may be determined. The quantity of wagering opportunities may comprise a first group or subgroup of the one or more wagering opportunities. For example, the quantity of wagering opportunities may comprise a parlay. The quantity of wagering opportunities may comprise or otherwise be associated with one or more parameters. For example, a first parameter of the one or more parameters may comprise a number of legs of a parlay. A parlay is a type of bet where multiple individual wagers may be combined into a single bet. Each individual wager within a parlay may be referred to as a “leg” or a “selection.” The legs of a parlay represent the separate bets or outcomes that the bettor is combining. For example, a second parameter may comprise odds of the parlay hitting (e.g., a better successfully wagering on every leg of the parlay). Parlay odds may be determined by multiplying the individual odds of each leg together. For example, if you have a 3-leg parlay and each leg has odds of 2.00 (even money or 2:1), the parlay odds would be calculated as 2.00×2.00×2.00=8.00 (or 8:1). For example, the odds of a long, complicated parlay may be 10,000:1. A parlay may be a series or a sequence of wagers, where a successful first wager may be parlayed into a subsequent wager, and so on. For example, a parlay may comprise a cumulative series of bets in which winnings accruing from each transaction are used as a stake for a further bet.

At 740, the quantity of wagering opportunities may be output. Outputting the quantity of wagering opportunities may comprise launching one or more applications on the media device 120 and/or the mobile device 124. For example, in response to the query, the supplemental feature source 108 may send the quantity of wagering opportunities and metadata associated with the quantity of wagering opportunities. The metadata associated with the quantity of wagering opportunities may be configured to cause a device (e.g., the media device 120 and/or the mobile device 124) to launch one or more applications, open one or more web pages, or other similar actions configured to cause output of the quantity of wagering opportunities. Outputting the quantity of wagering opportunities may comprise causing output of one or more interactive interfaces (e.g., one or more user interfaces) configured to display the quantity of wagering opportunities and configured to receive one or more user inputs associated therewith.

The method may comprise receiving, via the media device, one or more wagers associated with the one or more wagering opportunities. The method may comprise receiving the one or more user inputs. For example, the one or more user inputs may comprise one or more wagers. For example, a user may select (e.g., via a remote control, via voice control, via a user device such as a smartphone) the one or more wagering opportunities. The method may comprise determining one or more results associated with the one or more wagering opportunities. The method may comprise determining a content history associated with the media device, wherein the content history comprises one or more of: one or more athletic events, one or more competitions, one or more game shows, one or more political events, or one or more entertainment events. The method may comprise determining one or more of: one or more bookmaking odds or jurisdictional rules related to gambling.

FIG. 8 shows a flowchart of a method 800 for content management. The method 800 may be carried out on any one or more of the devices described in FIGS. 1A-1B, FIG. 2, FIG. 3, and/or FIG. 10. At 810, a user account may be determined. The user account may be associated with a user device. The user device may comprise, for example, a television, a computer, a phone, a voice activated device, or any other type of device. For example, the user device may comprise the media device 120 and/or the mobile device 124. The user account associated with the user device may be determined by virtue of the user device being activated. The user account may be determined based on one or more credentials (e.g., one or more identifiers) associated with the user device and/or the user account.

The user account may be determined by, for example, the supplemental feature source 108. The supplemental feature source, for example, may receive an indication of the user account from the media device 120 and/or the mobile device 124. The supplemental feature source may comprise a sportsbook or other wagering service provider.

At 820, a content history associated with the user account may be determined. The content history may comprise content consumption data. The content consumption data may indicate content consumed on the user device. The content consumption data may comprise information and metrics indicating, for example, when, and for how long, a user associated with the user account consumed content. For example, the content history may comprise a viewing history.

At 830, one or more available content items may be determined. The one or more available content items may be determined based on the content history associated with the user account. The one or more available content items may be one or more on demand content items, one or more content items currently being broadcast, one or more content items scheduled for broadcast at some point in the future, combinations thereof, and the like. For example, the content history may indicate a user account regularly tunes into certain St. Louis Cardinals baseball games, Atlanta Braves baseball games, Boston Celtics basketball games, PGA tour events, and UFC fights. Thus, the one or more available content items may comprise one or more currently occurring and/or upcoming (e.g., available, scheduled for broadcast) St. Louis Cardinal baseball games, one or more Atlanta Braves games, one or more Celtics games, one or more PGA tour events, and/or UFC fights.

At 840, one or more wagering opportunities associated with the one or more available content items may be determined. The one or more wagering opportunities may comprise, for example, a parlay featuring one or more wagering opportunities associated with the one or available content items. For example, the one or more wagering opportunities may comprise one or more over/unders, one or more win/losses, or any prop bets associated with the available content items. For example, the supplemental feature source may query one or more gambling databases (e.g., sportsbooks) to determine the one or more wagering opportunities and may send the one or more wagering opportunities to, for example, the media device 120 and/or the mobile device 124. A parlay may be a series or a sequence of wagers, where a successful first wager may be parlayed into a subsequent wager, and so on. For example, a parlay may comprise a cumulative series of bets in which winnings accruing from each transaction are used as a stake for a further bet.

At 850, one or more parlays may be built based on the one or more wagering opportunities. A parlay may be a series or a sequence of wagers, where a successful first wager may be parlayed into a subsequent wager, and so on. For example, a parlay may comprise a cumulative series of bets in which winnings accruing from each transaction are used as a stake for a further bet. A parlay may comprise one or more wagering opportunities associated with one or more events (e.g., all wagering opportunities in the parlay need not be associated with the same event, though they may be).

The method may comprise outputting the one or more wagering opportunities. Outputting the one or more wagering opportunities may comprise launching one or more applications on the media device 120 and/or the mobile device 124. For example, in response to the query, the supplemental feature source 108 may send the one or more wagering opportunities and metadata associated with the one or more wagering opportunities. The metadata associated with the one or more wagering opportunities may be configured to cause a device (e.g., the media device 120 and/or the mobile device 124) to launch one or more applications, open one or more web pages, or other similar actions configured to cause output of the one or more wagering opportunities. Outputting the one or more wagering opportunities may comprise causing output of one or more interactive interfaces (e.g., one or more user interfaces) configured to display the one or more wagering opportunities and configured to receive one or more user inputs associated therewith.

The method may comprise receiving the one or more user inputs. For example, the one or more user inputs may comprise one or more wagers. For example, a user may select (e.g., via a remote control, via voice control, via a user device such as a smartphone) the one or more wagering opportunities. The method may comprise determining one or more results associated with the one or more wagering opportunities. The method may comprise determining a content history associated with the media device, wherein the content history comprises one or more of: one or more athletic events, one or more competitions, one or more game shows, one or more political events, or one or more entertainment events. The method may comprise determining one or more of: one or more bookmaking odds or jurisdictional rules related to gambling.

FIG. 9 shows an example method 900. The method 900 may be carried out on any one or more of the devices described in FIGS. 1A-1B, FIG. 2, FIG. 3, and/or FIG. 9. At step 910, primary content may be received. For example, the primary content may be received by media device 120, mobile device 124, or any other device. The primary content may be live content, on-demand content, or any other content.

At 920, it may be determined that the primary content comprises an event associated with one or more wagering opportunities. For example, it may be determined that the primary content comprises an event associated with one or more wagering opportunities based on metadata associated with the content (e.g., title, channel, or any other data associated with the content). For example, the media device 120 may determine the primary content comprises a sporting event (e.g., a basketball game on TNT). The media device 120 may determine the event is eligible for wagering.

At 930, a request for one or more wagering opportunities may be sent. For example, the media device, based on determining the primary content is associated with an event that is associated with one or more wagering opportunities, may send, to the supplemental feature source 108, a request for the one or more wagering opportunities. For example, the supplemental features source 108 may comprise a sportsbook or some other entity that provides wagering (e.g., gambling) services. For example, the media device 120 may send a query to the supplemental feature source. The query may request the supplemental feature source to send one or more wagering opportunities to the media device 120 and/or the mobile device 124.

The query may be configured to indicate content consumption associated with, for example, the media device 120 and/or the mobile device 124. For example, the query may indicate the content currently being consumed by (e.g., received by, output by) the media device 120 and/or the mobile device 124. The supplemental feature source 108 may determine, based on the content indicated in the query, the one or more wagering opportunities. The one or more wagering opportunities may comprise, for example, one or more parlays associated with the content. For example, if the primary content is an NBA game, the one or more parlays may comprise an over/under, a win/loss, one or more prop bets (e.g., proposition bets, wagers not tied to the final score or outcome of a contest), combinations thereof, and the like. The aforementioned are merely exemplary and are not intended to be limiting in any way. A person skilled in the art will understand that the one or more wagering opportunities may comprise any wagering opportunity.

At 940, a parlay may be received. The parlay may be received based on the request. The parlay may comprise the one or more wagering opportunities. The one or more wagering opportunities may be received. For example, the supplemental feature source 108 may determine and send (e.g., aggregate, compile, etc.) the one or more wagering opportunities and send the one or more wagering opportunities to the media device 120.

At 950, the parlay may be output. Outputting the parlay may comprise launching one or more applications on the media device 120 and/or the mobile device 124. For example, in response to the query, the supplemental feature source 108 may send the one or more wagering opportunities and metadata associated with the one or more wagering opportunities. The metadata associated with the one or more wagering opportunities may be configured to cause a device (e.g., the media device 120 and/or the mobile device 124) to launch one or more applications, open one or more web pages, or other similar actions configured to cause output of the one or more wagering opportunities. Outputting the one or more wagering opportunities may comprise causing output of one or more interactive interfaces (e.g., one or more user interfaces) configured to display the one or more wagering opportunities and configured to receive one or more user inputs associated therewith.

The method may comprise receiving the one or more user inputs. For example, the one or more user inputs may comprise one or more wagers. For example, a user may select (e.g., via a remote control, via voice control, via a user device such as a smartphone) the one or more wagering opportunities. The method may comprise determining one or more results associated with the one or more wagering opportunities. The method may comprise determining a content history associated with the media device, wherein the content history comprises one or more of: one or more athletic events, one or more competitions, one or more game shows, one or more political events, or one or more entertainment events. The method may comprise determining one or more of: one or more bookmaking odds or jurisdictional rules related to gambling.

FIG. 10 shows a system 1000 for content management. The media device 120, the display device 121, the communication terminal 122, the mobile device 124, the advertisement server 106, the content source 102, the encoder 102, and/or the network component 129 of FIG. 1 may be a computer 1001 as shown in FIG. 10. The user device 202, the network device 204, the content device 206, and/or the computing device 208 of FIG. 2 may be a computer 801 as shown in FIG. 10. The computer 1001 may comprise one or more processors 1003, a system memory 1012, and a bus 1013 that couples various system components including the one or more processors 1003 to the system memory 1012. In the case of multiple processors 1003, the computer 1001 may utilize parallel computing. The bus 1013 is one or more of several possible types of bus structures, including a memory bus or memory controller, a peripheral bus, an accelerated graphics port, or local bus using any of a variety of bus architectures.

The computer 1001 may operate on and/or comprise a variety of computer readable media (e.g., non-transitory). The readable media may be any available media that is accessible by the computer 1001 and may comprise both volatile and non-volatile media, removable and non-removable media. The system memory 1012 has computer readable media in the form of volatile memory, such as random access memory (RAM), and/or non-volatile memory, such as read only memory (ROM). The system memory 1012 may store data such as the feature data 1007 and/or program modules such as the operating system 1005 and the feature software 1006 that are accessible to and/or are operated on by the one or more processors 1003. The machine learning module may comprise one or more of the feature data 1007 and/or the feature software 1006.

The computer 1001 may also comprise other removable/non-removable, volatile/non-volatile computer storage media. FIG. 10 shows the mass storage device 1004 which may facilitate non-volatile storage of computer code, computer readable instructions, data structures, program modules, and other data for the computer 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 1004, such as the operating system 1005 and the feature software 1006. Each of the operating system 1005 and the feature software 1006 (or some combination thereof) may comprise elements of the program modules and the feature software 1006. The feature data 1007 may also be stored on the mass storage device 1004. The feature data 1007 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 1015.

A user may enter commands and information into the computer 1001 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1003 via a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

The display device 1011 may also be connected to the bus 1013 via an interface, such as the display adapter 1009. It is contemplated that the computer 1001 may comprise more than one display adapter 1009 and the computer 1001 may comprise more than one display device 1011. The display device 1011 may be a monitor, an LCD (Liquid Crystal Display), light emitting diode (LED) display, television, smart lens, smart glass, and/or a projector. In addition to the display device 1011, other output peripheral devices may be components such as speakers (not shown) and a printer (not shown) which may be connected to the computer 1001 via the Input/Output Interface 1010. Any step and/or result of the methods may be output (or caused to be output) in any form to an output device. Such output may be any form of visual representation, including, but not limited to, textual, graphical, animation, audio, tactile, and the like. The display device 1011 and computer 1001 may be part of one device, or separate devices.

The computer 1001 may operate in a networked environment using logical connections to one or more remote computing devices 1014A,B,C. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 1001 and a remote computing device 1014A,B,C may be made via a network 1015, such as a local area network (LAN) and/or a general wide area network (WAN). Such network connections may be through the network adapter 1008. The network adapter 1008 may be implemented in both wired and wireless environments. Such networking environments are conventional and commonplace in dwellings, offices, enterprise-wide computer networks, intranets, and the Internet.

Application programs and other executable program components such as the operating system 1005 are shown herein as discrete blocks, although it is recognized that such programs and components reside at various times in different storage components of the computing device 1001, and are executed by the one or more processors 1003 of the computer. An implementation of the feature software 1006 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the quantity or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
determining a content consumption history associated with a user;
determining one or more available content items associated with one or more wagering opportunities;
determining, based on the content consumption history and the one or more available content items, a quantity of wagering opportunities of the one or more wagering opportunities; and
causing the quantity of wagering opportunities to be output to a media device associated with the user.

2. The method of claim 1, further comprising receiving, via the media device, one or more wagers associated with the one or more wagering opportunities.

3. The method of claim 1, wherein the content consumption history comprises one or more of: one or more athletic events, one or more competitions, one or more game shows, one or more political events, or one or more entertainment events.

4. The method of claim 1, further comprising combining the one or more wagering opportunities into a parlay.

5. The method of claim 1, wherein determining the quantity of wagering opportunities comprises determining one or more bookmaking odds.

6. The method of claim 1, wherein determining the quantity of wagering opportunities comprises determining one or more jurisdictional rules related to gambling.

7. The method of claim 1, wherein determining the content consumption history associated with the user comprises:
determining one or more user identifiers associated with the user; and
determining one or more content requests associated with the one or more user identifiers.

8. The method of claim 1, further comprising:
causing the media device to activate an application; and
causing the media device to output an interface associated with the application.

9. A method comprising:
determining a user account associated with a user device;
determining a content consumption history associated with the user account;
determining, based on the content consumption history, one or more available content items;
determining one or more wagering opportunities associated with the one or more available content items; and
building, based on the one or more wagering opportunities, a parlay.

10. The method of claim 9, wherein the content consumption history comprises one or more of: one or more athletic events, one or more competitions, one or more game shows, one or more political events, or one or more entertainment events.

11. The method of claim 9, wherein the parlay comprises an ordered series of the one or more wagering opportunities.

12. The method of claim 9, wherein the one or more available content items comprise one or more events scheduled for broadcast.

13. The method of claim 9, wherein determining the one or more wagering opportunities comprises determining one or more bookmaking odds.

14. The method of claim 9, wherein determining the one or more wagering opportunities comprises determining one or more jurisdictional rules related to gambling.

15. The method of claim 9, further comprising:
outputting the one or more wagering opportunities via the user device; and
receiving, based on the one or more wagering opportunities, one or more wagers.

16. The method of claim 9, further comprising:
causing the user device to activate an application; and
causing the user device to output an interface associated with the application.

17. A method comprising:
receiving, by a media device, primary content;
determining the primary content comprises an event that is eligible for one or more wagering opportunities;
sending, based on the event, a request for the one or more wagering opportunities;
receiving, based on the request, a parlay comprising the one or more wagering opportunities; and
outputting the parlay via the media device.

18. The method of claim 17, further comprising receiving one or more wagers associated with the parlay.

19. The method of claim 17, further comprising determining a content consumption history associated with the media device, wherein the content consumption history comprises one or more of: one or more athletic events, one or more competitions, one or more game shows, one or more political events, or one or more entertainment events.

20. The method of claim 17, further comprising combining the one or more wagering opportunities into a parlay.

21. The method of claim 17, further comprising determining one or more of: one or more bookmaking odds or jurisdictional rules related to gambling.

22. The method of claim 17, further comprising:
causing the media device to activate an application; and
causing the media device to output an interface associated with the application.
